(19) United States
(12) Patent Application Publication
(10) Pub. No.: US 2023/0160413 A1
(43) Pub. Date: May 25, 2023

(54) Threaded Fastener With Scalloped Minor Diameter

(71) Applicant: OMG, Inc., Agawam, MA (US)

(72) Inventor: Douglas R. Theroux, Holyoke, MA (US)

(21) Appl. No.: 17/993,539

(22) Filed: Nov. 23, 2022

Related U.S. Application Data
(60) Provisional application No. 63/282,311, filed on Nov. 23, 2021.

(51) Int. Cl. F16B 35/04

(52) U.S. Cl. CPC F16B 35/041

(57) ABSTRACT

A fastener has a head and a shank extending from the head to a tip. The shank has a threaded distal portion that includes primary threads defining a major diameter, a minor diameter, and at least one helical rib or scalloped surface at the minor diameter. The at least one rib extends between adjacent primary threads of the threaded portion and extends in a helical configuration. The configuration of the fastener with helical ribs in the minor diameter reduces contact surface area between the fastener and building material substrate, like wood, during installation of the fastener, which thereby results in less torquing force required for installation.

### BACKGROUND

This disclosure relates generally to a threaded fastener, and more particularly to a threaded fastener having a modified minor diameter, which reduces the torque required for installation, especially in wooden building materials.

In construction and building fields, fasteners such as wood screws are common for assisting in the connection of one building member to another building member (such as dimensional lumber used for deck boards or framing, for example). A common problem associated with known wood screws is difficulty in the installation process due to high installation torques required which can result in laborious and time consuming projects. Additionally, high torquing forces can cause inconsistencies and a reduction in strength and integrity with building structures due to high stresses exerted on the wood screw and building substrates.

Accordingly, there is a need to provide an improved fastener allowing for ease of installation and reduction of torque required while maintaining robust and reliable configurations.

### SUMMARY

In one embodiment, a fastener comprises a head and a shank extending from the head to a tip. The shank comprises a threaded distal portion that includes primary threads defining a major diameter, a minor diameter, and at least one rib at the minor diameter. The at least one rib extends between adjacent primary threads of the threaded portion and extends in a helical configuration.

In some embodiments, the fastener includes a plurality of helical ribs in the minor diameter.

In some embodiments, the rotations per inch of the ribs are less than threads per inch of the primary threads.

In some embodiments, the helical ribs have convex curved outer contour.

In some embodiments, the helical ribs are semi-circular in cross section.

In some embodiments, the nominal height of the at least one rib is at least 50% the nominal height of the primary threads.

In some embodiments, the fastener with helical ribs exhibits a reduction in contact surface area during installation of at least 5% compared to a fastener of like dimensions without helical ribs.

### BRIEF DESCRIPTION OF THE DRAWINGS

The foregoing aspects and other features of the disclosure are explained in the following description, taken in connection with the accompanying drawings, wherein:

FIG. 1 is a perspective view of an embodiment of the disclosed fastener;

FIG. 2 is a side view of the fastener shown in FIG. 1;

FIG. 3 is an enlarged view of a threaded portion of the fastener shown in FIG. 1;

FIG. 4 is a section view of the fastener shown in FIG. 1; and

FIG. 5 depicts another embodiment of the disclosed fastener with helical ribs running in the opposite rotational direction from the primary threads;

FIG. 6 shows another embodiment of the disclosed fastener, including enlarged views of several key portions of the fastener;

FIG. 7 is an enlarged cross-sectional view of the fastener of FIG. 5 showing the helical ribs without primary threads; and

FIG. 8 is a cross-sectional view of the fastener of FIG. 5.

### DETAILED DESCRIPTION

Among the benefits and improvements disclosed herein, other objects and advantages of the disclosed embodiments will become apparent from the following wherein like numerals represent like parts throughout the figures. Detailed embodiments of a threaded fastener with scalloped minor diameter are disclosed; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may. The phrases “in another embodiment” and “in some other embodiments” as used herein do not necessarily refer to a different embodiment, although it may. Thus, as described below, various embodiments may be readily combined without departing from the scope or spirit of the invention.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

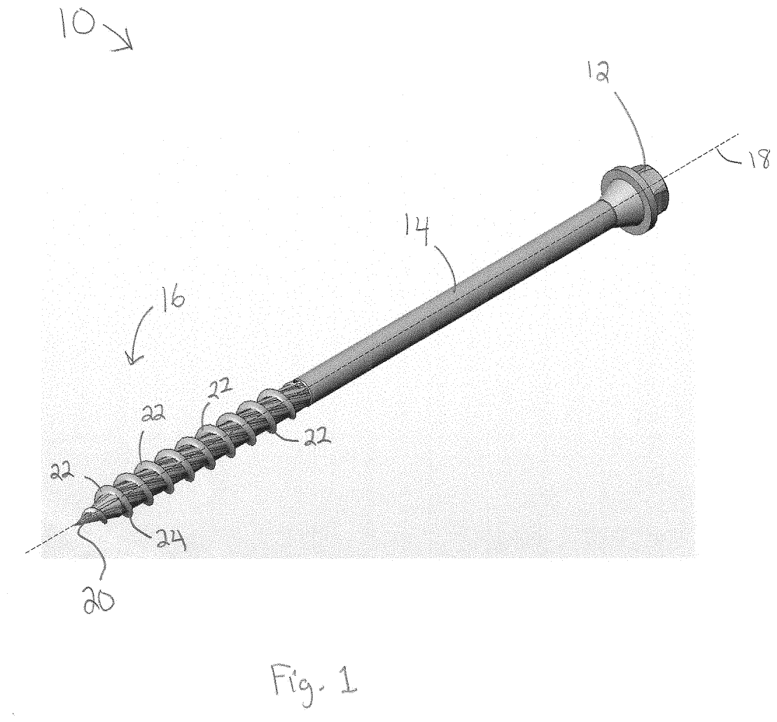

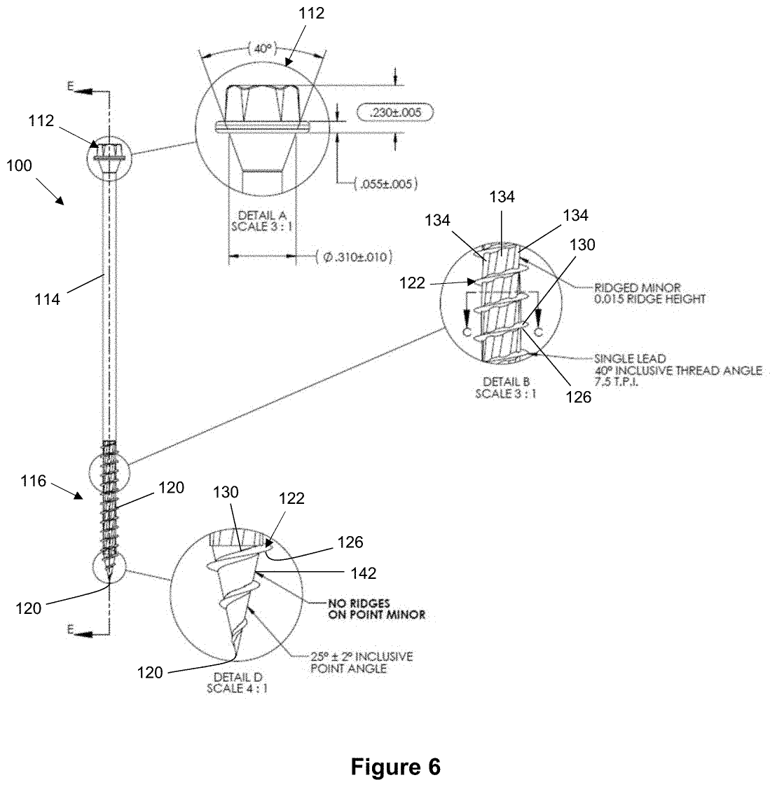

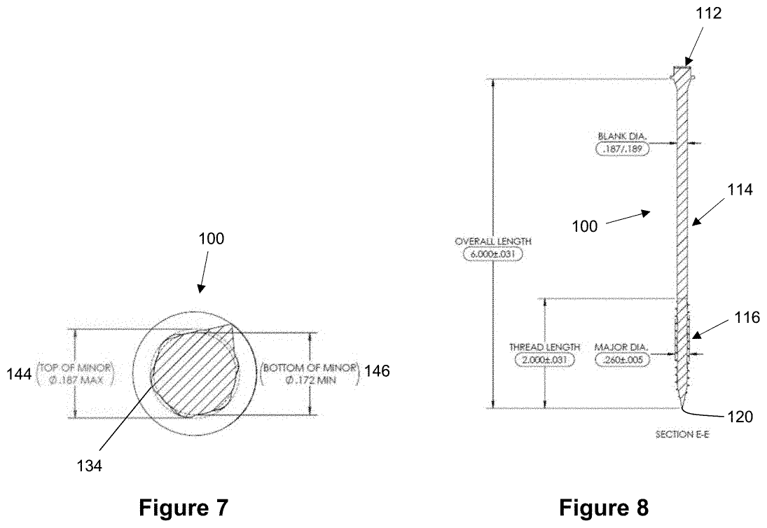

With reference to the drawings wherein like numerals represent like parts throughout the figures, there is shown a perspective view of a fastener 10 incorporating features of the disclosure (see FIG. 1). Although the disclosed embodiments will be described with reference to the exemplary embodiments shown in the drawings, it should be understood that the various exemplary embodiments can be embodied in many alternate forms of embodiments. Further, the embodiments are primarily discussed with reference to use with wooden building materials. While this is a particularly preferred embodiment, the disclosed fasteners are not limited to use with wood, and can be used with other known building materials, including composites. In addition, any suitable size, shape or type of elements or materials can be used. FIGS. 6-8 specifically identify key dimensions, angles and other data concerning a particularly preferred embodiment. It should also be noted that these specific data points are non-limiting in their specific sense. However, fasteners with individual elements having dimensions relative to one another like or similar to those identified in FIGS. 6-8—especially ratios of thread height to helical rib height, thread pitch to helical rib height, and threads per inch (TPI) to rotations per inch (RPI) of the ribs—have been shown to be particularly effective and well suited to reducing torque required for installation.

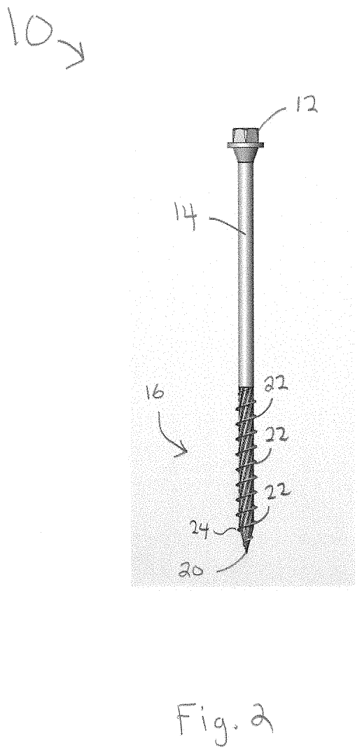

As shown first in FIGS. 1 and 2, an embodiment of the fastener 10, which may be a wood screw for example, includes a head 12, and a shank with an unthreaded proximal portion 14 and a threaded distal portion 16. The shank 14 comprises a cylindrical body (about a longitudinal axis 18 of the fastener) and extends from the head 12 to a distal tip 20. The threaded portion 16 extends from the unthreaded portion 14 to a tapered distal end where the screw tip 20 is located.

The head 12 of the screw 10 is provided with an opening in the head 12 for receiving a tool, such as a drill bit or screwdriver, which can be used to drive the screw into the wood. According to various exemplary embodiments, the head may be provided with a Phillips head, flat head, or square socket configuration. Additionally, the head can have a hex-shape, as shown in the embodiment of FIGS. 6-8. In alternate embodiments, any suitable type of tool interface may be provided.

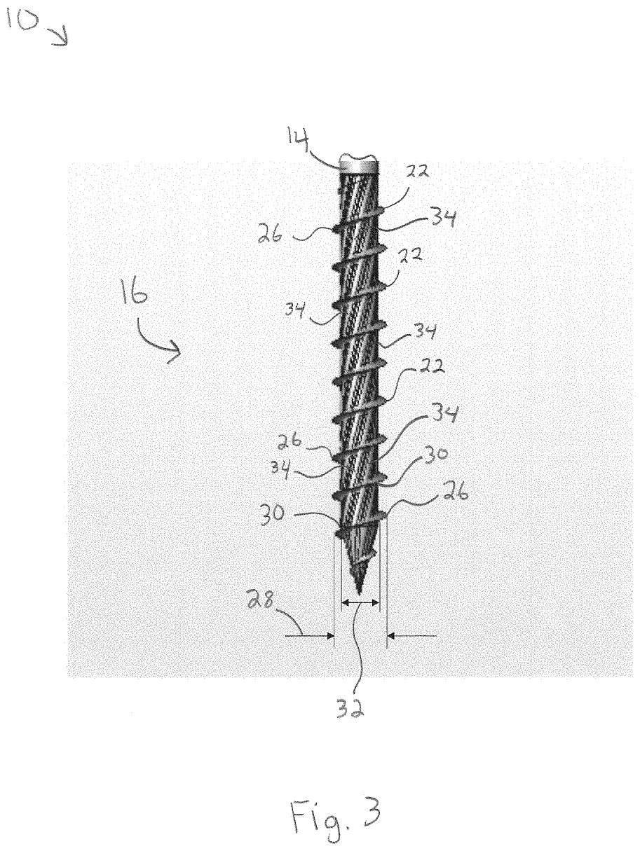

Referring now also to FIG. 3, the tip 20 is provided with a sharp point to allow it to bore through the corresponding material. The tip may be a sharp gimlet tip such as one exhibiting a 20° to 30° included angle, however any suitable tip configured for boring through a material such as wood, for example, may be provided. The threaded portion 16 is provided with primary threads (or thread sections) 22 such as one arrayed in a continuous helical ridge 24 that starts near or at the tip 20, proceeds over the tapered distal end, and over the threaded portion to a location near the junction between the threaded portion and the unthreaded portion of the shank. Threads 22 may have any suitable major diameter, minor diameter, and/or thread configuration.

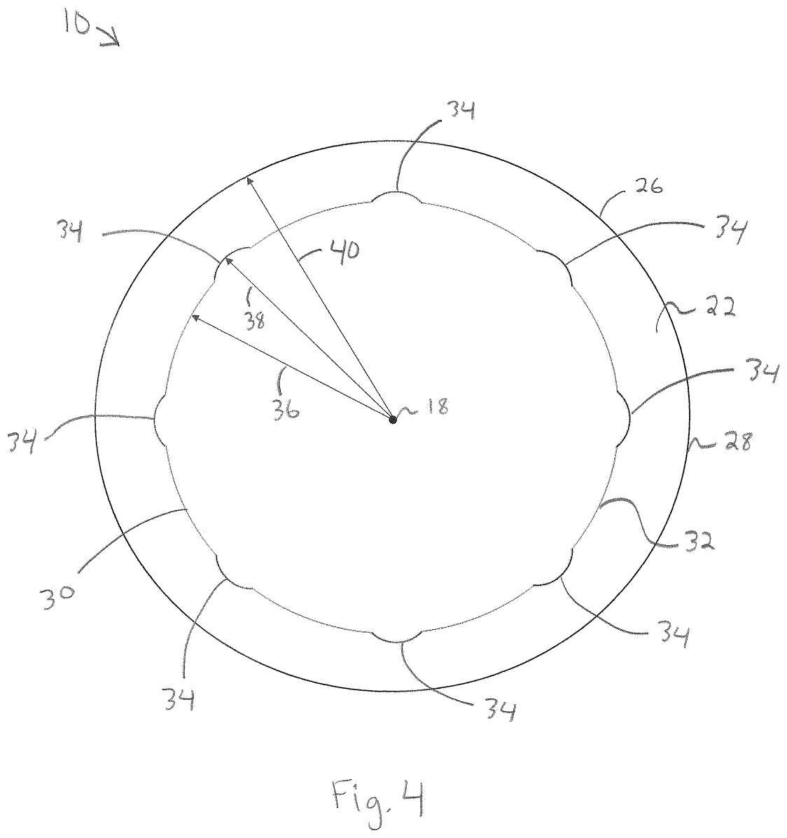

Each thread 22 includes a crest 26 at the top of the thread (for example at the major diameter 28) and a root 30 at the bottom of the thread 22 (for example at the minor diameter 32). Additionally, between each of the threads 22 there is provided a plurality of helical ribs 34 at the minor diameter (or root diameter) 32 which extend between adjacent ones of the threads 22. The ribs 34 each include a helical configuration extending between adjacent threads 22 and comprise a radial height that is between the corresponding radial height of the root 30 and the corresponding radial height of the crest 26 of each thread 22. For example, FIG. 4 illustrates a section view of the fastener 10 wherein the corresponding radial heights (from the longitudinal axis 18) are shown. The root radial height 36 (which is one half of the minor diameter 32) is less than the rib radial height 38, and the crest radial height 40 (which is one half of the major diameter 28) is greater than the rib radial height 38. Although FIG. 4 illustrates the rib radial height 38 as being closer to the height of the root 30 than to the height of the crest 26, alternate embodiments may comprise any suitable rib radial height that is less than the crest radial height but greater than the root radial height. Preferably, each rib has a radial height of 50% or more compared to radial height of primary threads. More preferably, the ribs have a radial height of 60% or greater compared to that of the primary threads. Even more preferably, the ribs have a radial height of 70% or greater compared to that of the primary threads. In the depicted preferred embodiment of FIGS. 6-8, the helical ribs have a radial height approximately 72% of the radial height of the primary threads. Additionally, it should be noted that the embodiment shown in FIG. 4 illustrates eight radially spaced ribs at a section between two adjacent threads, however alternate embodiments may comprise any suitable number of radially spaced ribs. Furthermore, in some other alternate embodiments, larger or smaller rib widths (or spacing/distance between the ribs) may be provided. Accordingly, any one or more of the various exemplary embodiments provide for the minor diameter to have ribbed features which appear as a “scalloped” configuration between each one of the threads.

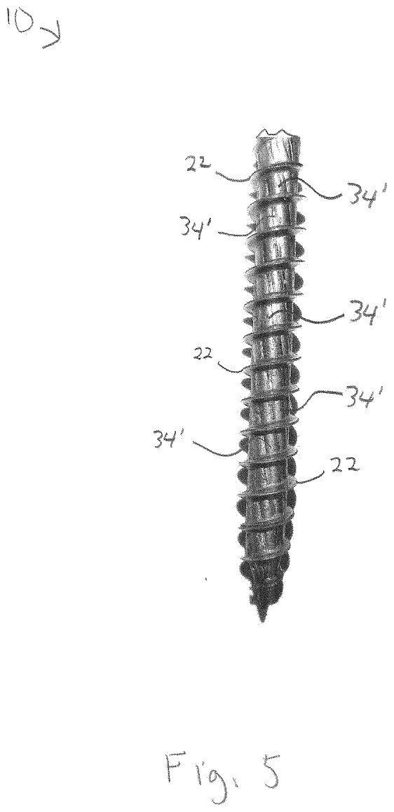

As best seen in FIG. 3, the helical ribs 34 are oriented such that the spiral configuration is in the same direction as the threads 22. However, the helical ribs 34 have fewer revolutions per inch (RPI) than threads per inch (TPI) of the primary threads 22. For example, according to the various exemplary embodiments, the RPI (around the minor diameter) of the helical ribs may be on the order of about 0.5 RPI, whereas the threads of the fastener may be about 7-32 TPI. It should be noted that although FIG. 3 illustrates the helical ribs 34 as being oriented such that the spiral configuration follows the same direction as the threads 22, alternate embodiments may provide for the helical ribs to be oriented such that the spiral configuration follows the opposite direction of the threads 22. For example FIG. 5 illustrates one such embodiment where ribs 34′ extend between the threads 22 in a similar fashion as in FIG. 3; however, the revolution direction of the helical ribs 34′ in the embodiment of FIGS. 1-4 is opposite the thread direction of the threads 22.

FIG. 6 depicts another embodiment of the disclosed fastener 100. This embodiment is substantially similar to the embodiment of FIGS. 1-5, except that the distal end of the fastener 100 includes a short tip section with minor diameter 142 that does not have helical ribs.

Notably, all elements in the fastener 100 common to the fastener 10 are identified with a common last two numerical digits, and a leading “1” for ease of understanding. As shown, a shank extends from the underside of a head 112 to a distal tip 120. The proximal section 114 of the shank is unthreaded and a distal portion 116 has threads 122 and a scalloped minor diameter formed via a plurality of helical ribs 134. In this embodiment, the ribs 134 run in the same rotational direction as the primary threads 122, and like in the earlier embodiment of the fastener 10, with fewer RPI than TPI of the primary threads 122. As shown, the ribs 134 are formed as semicircular or convex raised ridges on the minor surface of the fastener shank. This relatively smooth curved outer contour of the ribs has shown particular efficacy in reducing contact surface area, and therefore torque required for installation.

As shown in FIG. 6, the top of the minor diameter (i.e., ribbed section) is approximately 0.187 inches in the radial direction and the bottom of the minor diameter (i.e., non-ribbed section) is approximately 0.172 inches in the radial direction. Thus, a difference of only 0.015 inches (each individual rib nominal height 0.0075 inches) between maximum minor diameter and minimum minor diameter can substantially reduce the contact surface area between the fastener and the building material substrate (wood fibers or composite material) enough to materially reduce torque required for installation. Preferably, the maximum minor diameter (ribbed section) is approximately 0.005 and 0.30 inches greater than the minimum minor diameter (non-ribbed section), and more preferably between approximately 0.010 and 0.020 inches.

Preferably, each rib has a nominal height (in the radial direction from the non-ribbed minor diameter to the apex of each curved rib) of between 0.0025 inches and 0.125 inches, and more preferably between approximately 0.005 inches and 0.100 inches. The depicted preferred embodiment includes ribs that each have a nominal height of approximately 0.0075 inches.

Preferably, the disclosed configuration of the fastener, 10 and 100, with helical ribs, 34 and 134, in the minor diameter between primary threads, 22 and 122, leads to a reduction in surface area contact between the fastener and building material substrate of above 5%, and more preferably above 10%, and even more preferably above 20%. In preferred embodiments, the fastener may exhibit a reduction in surface area contact compared to a fastener of like dimensions without ribs of between 5% and 50%, and more preferably between 10% and 40%, and even more preferably between 15% and 35%, and even more preferably between 20% and 30%. In a particularly preferred embodiment, the fastener exhibits a reduction in surface area contact with the substrate of approximately 25%. Testing has shown that this embodiment of the inventive fastener with helical ribs exhibits a reduction in install torque of approximately 15% compared to a fastener of like dimensions without helical ribs.

The fastener 10/100 can be made from carbon steel or any other suitable material used in making wood screws or fasteners. According to the various exemplary embodiments, the threads can be provided by using a thread cutting process, such as by using a split circular die held in a die stock, for example. Additionally, allowing cross nicks to confine the thread die during the thread cutting process provides for formation of the ribbed features at the minor diameter. In a preferred embodiment, the helical ribs are formed using the same process as the threads—they are cut into the surface of the thread dies using a ball end mill in a CNC mill. The helical ribs are then rolled onto the surface of the minor of the fastener when the threads are formed. In alternate embodiments, other suitable methods of providing the threads may be employed.

In the preferred embodiment depicted in FIGS. 6-8, the shank is approximately 6.0 inches long and the threaded section is approximately 2.0 inches long, i.e., the threaded section comprises approximately ⅓ of the shank length. This ratio has been found to be suitable and effective for a variety of uses primarily in wooden materials, however, it is non-limiting to the inventive nature of the fastener with scalloped minor diameter. Embodiments exist with a relatively shorter unthreaded section, up to and including no unthreaded section at all. Additionally, the absolute dimensions shown in the drawings and discussed herein are preferred and non-limiting.

Technical effects of the one or more exemplary embodiments include significant advantages over conventional wood screws, such as providing a robust building assembly where the torque required for installation is noticeably reduced due to a reduction in contact surface area from the configuration of the ribs at the minor diameter. The ribs reduce the surface area that contacts the wood grain/fibers at the minor diameter. This reduction in contact surface area, between the minor diameter and the substrate (i.e., wood grain/fibers or composite material), provides for the reduced torque during installation. This is beneficial to the installer as reduced installation torque can provide a less strenuous process (and less time consuming) when driving the screw into the corresponding wood member. Additionally, the reduced torque during installation can provide for less power consumption for battery operated installation tools (as less driving force is needed if the install torque is reduced). Additionally, the reduced installation torque reduces stress exerted on the fastener and substrate materials during installation which results in reduction in likelihood of fastener failure, and thus extended fastener life.

While the various exemplary embodiments have been described above in connection with the minor diameter having helical ribs, one skilled in the art will appreciate that the exemplary embodiments are not necessarily so limited and that alternate embodiments may comprise any other helical features at the minor diameter such as helical raised portions, helical protuberances, helical wave features, or any other raised ridge features that provide for reduced contact surface area between the minor diameter and the corresponding wood member. Additionally, in some embodiments, the raise portions may have a non-helical configuration.

It should be understood that the foregoing description is only illustrative of the various exemplary embodiments. Various alternatives and modifications can be devised by those skilled in the art without departing from the disclosure. Accordingly, the disclosure is intended to embrace all such alternatives, modifications and variances which fall within the scope of the disclosure.

What is claimed is:

1. A fastener comprising:
a head; and
a shank extending from the head to a tip and comprising a threaded distal portion, wherein
threaded distal portion includes primary threads defining a major diameter, a minor diameter, and at least one rib at the minor diameter, and
the at least one rib extends between adjacent primary threads of the threaded portion, and
the rib extends in a helical configuration.

2. The fastener of claim 1, wherein the rib comprises a radial height that is less than a radial height of a crest of one of the adjacent threads.

3. The fastener of claim 1, wherein the rib comprises a radial height that is greater than a radial height of a root of one of the adjacent threads.

4. The fastener of claim 1, wherein the at least one rib comprises a plurality of ribs spaced along the minor diameter.

5. The fastener of claim 4, wherein the plurality of ribs comprises a helical configuration.

6. The fastener of claim 1, wherein the at least one rib is helical with fewer rotations per inch (RPI) than threads per inch (TPI) of the primary threads.

7. The fastener of claim 1, wherein the rib has a convex curved outer contour.

8. The fastener of claim 1, wherein the rib has a nominal height that is 50% of a nominal height of the primary threading measured in a radial direction.

9. The fastener of claim 8, wherein the rib has a nominal height that is between 50% and 85% of the nominal height of the primary threading measured in the radial direction.
